(19) United States
(12) Patent Application Publication
(10) Pub. No.: US 2004/0010517 A1
(43) Pub. Date: Jan. 15, 2004

(54) System and method for assisting an organization to implement and maintain compliance with various obligations

(76) Inventor: Denis Fetherston, Auckland (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/602,354

(22) Filed: Jun. 23, 2003

Related U.S. Application Data
(63) Continuation of application No. 10/103,595, filed on Mar. 19, 2002, now abandoned.
Application No. 10/103,595 is a continuation of application No. 09/202,131, filed on Feb. 26, 1999, now abandoned.

(30) Foreign Application Priority Data
Aug. 29, 1996 (NZ) 286393
Aug. 15, 1997 (NZ) 328559
Aug. 29, 1997 (WO) PCT/NZ97/00106

(51) Int. Cl. G06F 7/00

(52) U.S. Cl. 707/104.1

(57) ABSTRACT

The invention comprises a system for assisting an organization to implement and maintain compliance management programs, the system comprising a plurality of modules relating to particular legislative or other obligations with which the organization is required to comply; at least one master database containing information on said legislative or other compliance obligations; at least one slave database containing and allowing entry of information of activities and incidents or accidents in the organization and assessments of the organization; and report generating means for generating a report on actions required to render the organization complaint with the legislative or other requirements in the master database.

### CROSS REFERENCE TO RELATED APPLICATIONS

This application is a continuation of U.S. patent application Ser. No. 10/103,595 entitled “SYSTEM AND METHOD FOR ASSISTING AN ORGANIZATION TO IMPLEMENT AND MAINTAIN COMPLIANCE WITH VARIOUS OBLIGATIONS” filed on Mar. 19, 2002, which in turn is a continuation of U.S. patent application Ser. No. 09/202,131 filed on Feb. 26, 1999, which application claims the benefit of International Application No. PCT/NZ97/00106, filed on Aug. 29, 1997, and which claims priority under 35 U.S.C. §119(a) to New Zealand Application Number 286393, filed on Aug. 29, 1996 and New Zealand Application Number 328559, filed on Aug. 15, 1997; each of which is hereby incorporated by reference in its entirety, including drawings.

### FIELD

The invention comprises a system and method for assisting the implementation and maintenance of compliance programs required by legislation or established through management objectives for the benefit of the organization.

### BACKGROUND

Programs to ensure compliance with various obligations placed on industry are driven by the legislation which places compliance obligations upon businesses, such as legislation concerning the protection of people, the environment, shareholders, equities and other business activities for example. Occupational health and safety legislation generally places the responsibility for the management of health and safety in the workplace in the hands of employers and their staff. This responsibility includes the prevention of harm to an employee by identifying and isolating hazards and where practical taking action to control, eliminate, and/or minimize hazards. The overall objective is to reduce workplace injuries, accidents, illnesses and fatalities through an effective health and safety management system.

Employers are generally required by law to provide an auditable trail of their actions that is sufficiently transparent to show they have an effective management programme Employers are generally required by law to provide an auditable trail of their actions that is sufficiently transparent to show they have an effective management programme which includes for example hazard identification, appropriate training and supervision of staff, recording details of all accidents and periodically reporting accidents to the appropriate investigative authority, establishing emergency procedures, and management of principals, contractors and subcontractors.

Similar legislative requirements apply to management of the effects a plant may have on the environment, and how under company law a company manages its shareholders assets.

Management within an organization may also establish compliance programs within the organization aimed at meeting a management objective within the organization, for example achieving and implementing procedures for ISO accreditation and implementation, particularly ISO 14001 and ISO 9001.

Many businesses are not able to manage the vast number of scenarios that can arise and certainly cannot manage these in a “real time mode”. Compliance may be required under legislation covering companies, health and safety, consumer protection, electricity, fair trading, human rights, privacy, environmental management, property, and land transport legislation. Risk management programs often tend to be reactive and address issues randomly. Many companies are not meeting the minimum required standards of compliance. This is partly due to a lack of commitment and understanding as to how to manage compliance issues, and the inability to be proactive towards the handling of the vast number of issues involved.

Many organizations have implemented paper and/or data based compliance programs, however these are not fully integrated and fully comprehensive. For example, to meet New Zealand Health and Safety Act (NZHSE Act) compliance requirements often each department of a company is supplied with a resource kit containing information on hazard identification, tools for hazard assessment, a serious harm schedule, information on how hazards are to be controlled, and forms to record the department hazard assessment. The intention is that each department record its own hazard identification on forms kept in that department's kit or in the system in some form. This type of programme, although adequate for each department if it is kept up to date, has proved inefficient for overall control as it is difficult to continue on an ongoing basis to identify and assess significant hazards, because this activity is not a natural part of the core operational business. It is also difficult to cross-reference hazards and control measures between departments or with others affected by hazards such as contractors.

For example, one department may engage in the activity of storing oil. This one activity may have many risk-causing aspects such as being stored near water or heat. Each of these aspects have a number of results which may occur if an event occurs such as environmental damage to waterways and wildlife through oil seepage, and injury or death to employees in the event of an explosion. Each effect has a number of controls involving recovery procedures and plans to minimize the risk.

For a department to ensure compliance it must implement all the necessary controls for a particular activity. This involves cross-referencing each activity to related aspects, effects and controls. In general a paper based system or conventional data based system is unable to assist in this process. The conventional interrelated data base approach is also unable to handle these requirements because of the large amount of data entry required and large number of controls for each activity. An exponentially increasing number of relationships between tables and other components of the database must be set up in advance by the database designer in such prior art systems.

### SUMMARY OF INVENTION

An object of the invention is to provide an improved system and method for assisting the implementation and maintenance of a compliance programme.

In broad terms the invention comprises a system for assisting an organization to implement and maintain compliance management programs, the system comprising a graphical interface which allows a user to display and enter data about legislative obligations or other obligations with which the organization is required to comply, the interface arranged to display a plurality of user-selectable modules, each module relating to a particular piece of legislation or obligation; at least one master database for storing compliance criteria on the legislative or other compliance obligations, the master database coupled to the graphical interface for displaying data about the legislative or other obligations; at least one slave database for storing information on activities of and incidents or accidents in the organization and assessments of the organization, the slave database coupled to the graphical interface for user entry of data about the activities of and incidents or accidents in the organization and assessments of the organization; risk assessor interfaced to assign a numerical priority rating to the activity, incident, accident or assessment in the slave database; and report generator for generating a report on any action required to render the organization compliant with the legislative or other requirements in the master database.

In a further aspect the invention comprises a computer-implemented method for assisting an organization to implement and maintain compliance management programs, comprising allowing a user to display and enter data through a graphical interface, wherein the data relates to legislative obligations or other obligations with which the organization is required to comply, the interface arranged to display a plurality of user-selectable modules, each module relating to a particular piece of legislation or obligation; storing compliance criteria on the legislative or other compliance obligations in at least one master database coupled to the graphical interface for displaying data about the legislative or other obligations; storing information on activities of and incidents or accidents in the organization and assessments of the organization in at least one slave database coupled to the graphical interface for user entry of data about the activities of and incidents or accidents in the organization and assessments of the organization; assigning to the activities, incidents, accidents or assessments a numerical priority rating and storing the priority rating in the slave database; retrieving data from the slave database about the organization; retrieving legislative or other compliance requirements from the master database; and generating a report on action to be taken to render the organization compliant with the legislative or other compliance requirements in the master database.

### BRIEF DESCRIPTION OF THE DRAWINGS

A preferred form of the method and system for assisting the implementation of a compliance programme will now be described by way of example and without intending to be limiting, with reference to the accompanying drawings in which:

FIG. 1 shows a preferred embodiment of the invention;

FIG. 2 illustrates the main menu screen of the preferred form system;

FIG. 3 shows the menu screen of one module of the system;

FIG. 4 details one option from the menu screen of FIG. 3;

FIG. 5 shows the menu screen of another module of the system;

FIG. 6 shows one option from the menu screen of FIG. 5;

FIG. 7 shows another option from the menu screen of FIG. 5;

FIG. 8 illustrates the navigation function of the invention;

FIG. 9 also illustrates the navigation function;

FIG. 10 illustrates a prior art data structure arrangement; and

FIG. 11 illustrates the data structure of the invention.

### DETAILED DESCRIPTION OF PREFERRED FORM

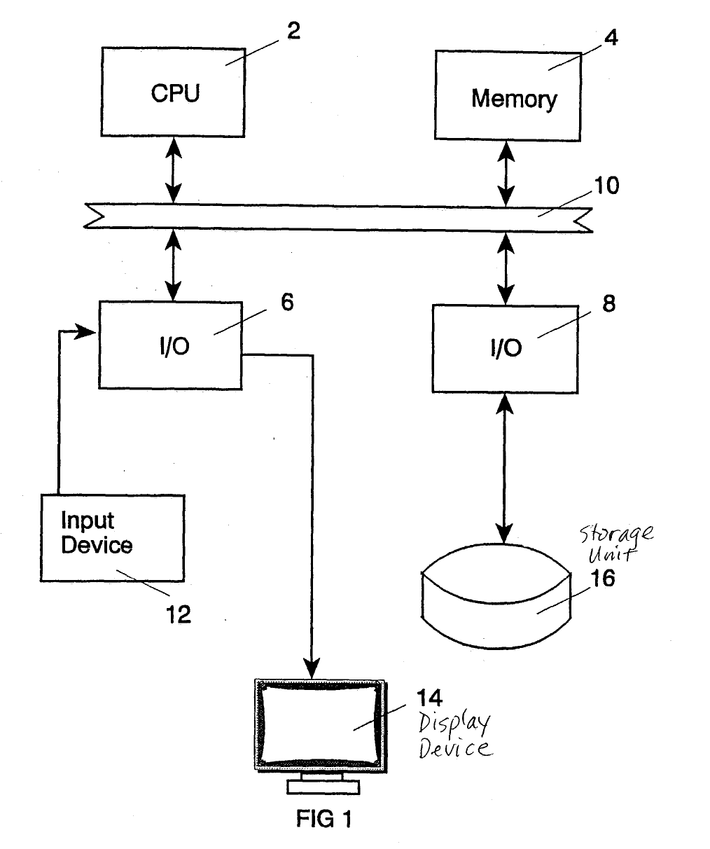

FIG. 1 shows one form of the invention. The system has a CPU (central processing unit) 2, a memory 4, and interface circuits 6 and 8, these four components being connected to each other by a system bus 10. The interface circuit 6 is connected to an input device 12, (for example a keyboard and mouse) and a display device 14. Interface circuit 8 is connected to a storage unit 16, such as a hard disk or floppy disk drive. Data input from the input device 12 is supplied to the CPU 2 via interface circuit 6 and system bus 10. Display data is supplied from CPU 2 to the display device 14 via the system bus 10 and interface circuit 6.

Preferably the invention is implemented on a PC having at least 16 MB RAM and operating system of Microsoft Windows 3.11, Windows 95, Windows 97, Memphis or Windows NT. Preferably Microsoft ACCESS has been installed on the storage unit 16 together with data and appropriate programmed software to support the invention. Alternatively the invention is installed on storage unit 16 as a stand alone application independent of Microsoft Access. Preferably storage unit 16 also has installed spreadsheet and word processing software, for example Microsoft Excel, AMIPRO, LOTUS and Microsoft Word.

Components 2, 4, 6, 8, 12, 14 and 16 may be set up as a stand-alone computer or may be connected to further components in a network. Networks may be of any type, for example internet, intranet, local area and wide area networks. The system may therefore be implemented on separate networked computers accessible from all or selected levels of an organization.

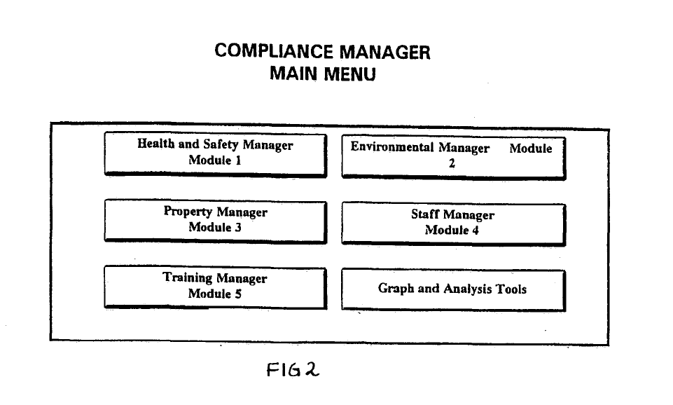

FIG. 2 illustrates the main menu of the preferred form system shown on display device 14. Using input device 12 a user may access as menu options a Health and Safety Manager module, an Environmental Manager module, a Property Manager module, a Staff Manager module, and a Training Manager module. Each module is related to a particular piece of legislation with which an organization must comply. Any system may include more or less or other similar modules, such as further modules related to various other pieces of legislation or modules relating to management established objectives and-procedures with which compliance is to be monitored, for example ISO accreditation and compliance.

The Health and Safety Manager module, accessible as an option from the main menu, is directed to compliance with occupational health and safety legislation under which organizations must typically establish effective methods for identifying and managing existing, new and potential instances of occupational overuse syndrome (OOS) in the workplace and regularly review these to see whether the instances of OOS are significant and require further action.

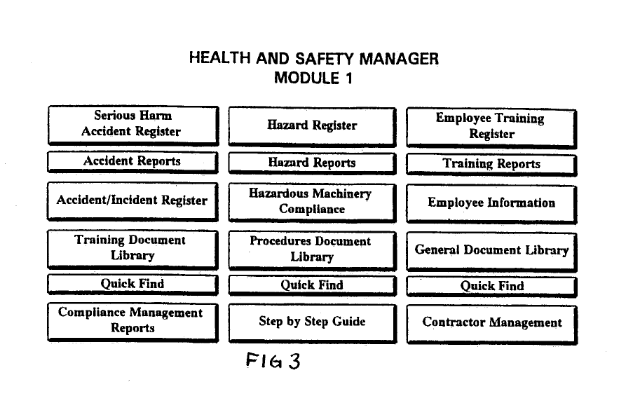

FIG. 3 shows the Health and Safety Manager module user screen presented to the user on display device 14. This screen displays a plurality of sub-modules which may be selected by the user with input device 12. Some of the sub-modules comprise text documents, for example the Training Document Library, the Procedures Document Library and the General Document Library. These allow various documents (for example on-line manuals on compliance requirements, standards and guidelines) to be stored in storage unit 16 and memory 4 for display on display unit 14 when selected by the user. The libraries may be preloaded on to storage unit 16 and preferably a user may also store further information in storage unit 16 based on operational experience to build up comprehensive information on the organization's compliance needs.

The Libraries form part of a conceptual master database of information, which may actually be implemented either as a single database in storage unit 16, or a plurality of linked databases installed on storage unit 16, or a plurality of databases installed on a plurality of storage units. The master database is in contrast to a conceptual slave database which may be installed on one or many storage units in the same way as the master database. The slave database is used to record information about an organization entered by the user. This information includes activities, aspects, effects and controls.

The invention preferably makes provision for supplementing the master database by the entry of compliance criteria data into master databases from company records and the user's experience as situations arise and policy and legislative requirements are imposed. For example an environmental compliance requirement driven by legislation and/or company policy has definable criteria and rules.

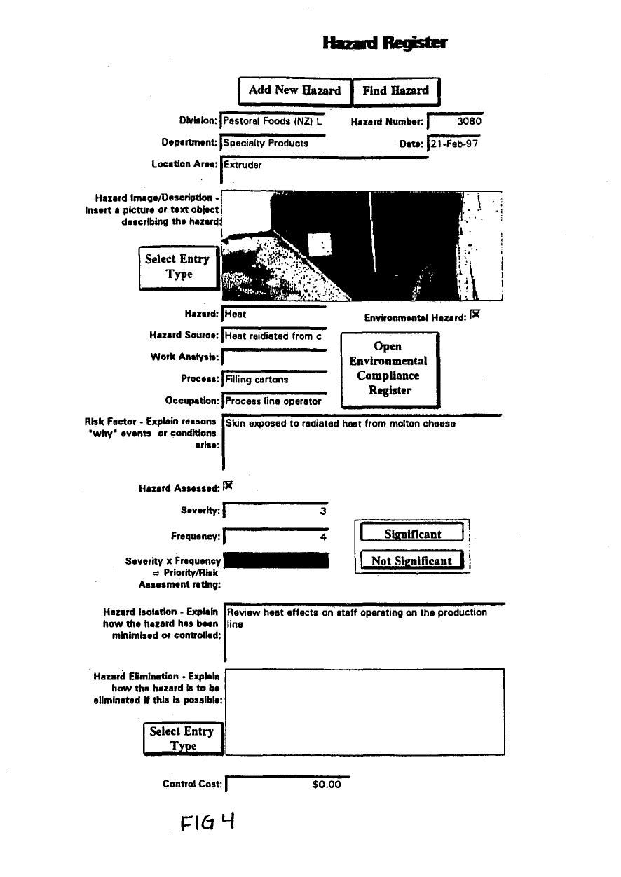

Another sub-module of the Health and Safety module, as shown in FIG. 3, is the Hazard Register. Using the input device 12, the user may select the Hazard Register which results in the form shown in FIG. 4 being presented on display device 14. The Hazard Register permits the user to store in the slave database information about hazards in an organization. A hazard may have been identified in a number of ways, for example an accident, an incident, a hazard or peril assessment, an audit or an observation. As shown in FIG. 4 the user is presented with a comprehensive data entry facility, eliciting information such as the particular division of the organization, a hazard description, hazard assessment and hazard isolation and so forth.

A common hazard in an office environment is the risk to computer operators of OOS.

This hazard is prevented by the use of appropriate office furniture and sensible work rules for example mandatory rests, and by training on correct posture. A portable or mounted digital camera may capture images of an operator's work station. Digital photographs of operator posture and work station ergonomics can then be loaded into the slave database of the Health and Safety Manager of the slave database and compared with a correct example from the master database.

The Hazard Register form allows users to enter data in a plurality of formats. One example is the use of a list-box or combo-box which retrieve a set of values from the master database for the user to select one value. For example, if the user selects the Hazard Source field in which to enter data, the Hazard Register form presents a number of alternatives from which the user may select a particular hazard source retrieved from the master database. Other formats which may be used include boxes in which text, numerals, currency values, true/false options and or OLE formats such as text documents. The Hazard Register form includes programmed macro software which ensures that the correct type of data is entered into each box. For example, the Hazard Register form includes macro software to ensure that a currency value is entered into the Control Cost box.

The Hazard Register, by way of example, forces the user to follow a process and pattern of data entry which ensures that relevant data is captured, as the relevant data must be entered by the user when viewing the Hazard Register on display device 14. As the user must in some cases select data from a list retrieved from the master database, this ensures that the data is meaningful. Screen displays show where action is required and reports on priority issues.

Following the steps on the various risk assessment forms, the invention retrieves data by searching through the fields in the master databases. This searching may be implemented in a number of ways, for example macro code to populate a list-box or combo-box, or code to quick-find keywords in a section of text or form. Alternatively the invention may comprise specific macro code segments for searching other components of the invention.

Data entered into the form is stored in the slave database installed in the storage unit 16 to form a profile and assessment criteria for the circumstance or activity being assessed.

The invention also includes a risk assessment means which constantly compares data in the slave database about events such as activities, incidents, accidents and assessments with compliance criteria from the master database. By way of example, the Hazard Register includes Severity and Frequency boxes. The user selects a value for the Severity box from a set of criteria retrieved from the master database. Preferably the range of values is from 1 (not severe) to 4 (very severe). The user also selects a value for the Frequency box from a range of values, preferably 1 (infrequent) to 5 (very frequent).

The invention determines a numerical priority or risk assessment rating as the product of severity and frequency, and places the rating in the rating box. The rating is assigned to the activity, incident, accident or assessment and stored in the slave database. The invention includes programmed macros which bring to the attention of the user hazards which exceed a certain rating and labels these hazards as significant. Preferably hazards with a risk assessment rating above a threshold of 10 are flagged as significant. The user may specify the threshold value, enabling an organization to concentrate first on high priority hazards by specifying a high threshold, then lowering the threshold to concentrate on lower priority hazards. Hazards flagged as significant preferably are continually brought to the attention of the user until all actions and performance criteria are met. Preferably the invention may produce reports detailing particular hazards at specific rating thresholds.

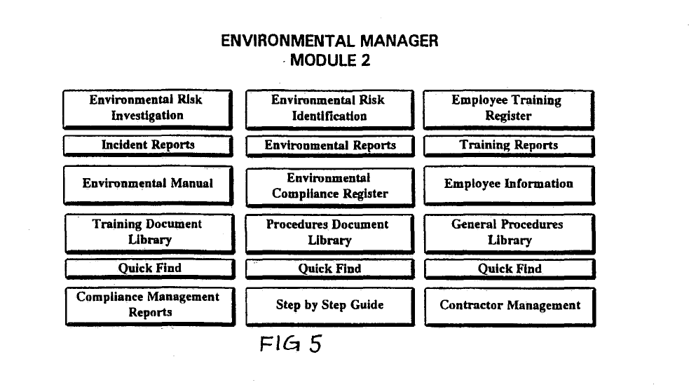

FIG. 5 shows the user screen for another module, the Environmental Manager module. This module comprises a number of sub-modules including a Training Document Library, Procedures Document Library, and General Procedures Library which contain information on environmental compliance requirements, and standards imposed by environmental protection legislation, and guidelines for compliance with the legislation. The data in the master database may be preloaded or may be input by the user based on operational experience to build up comprehensive information on the organization's compliance needs.

Again the Environmental Manager module provides the user with forms with which to update the slave data base containing data about events within the organization such as environmental incidents and assessment reports. The slave database may be updated using a number of sub-modules including Environmental Risk Investigation, Environmental Risk Identification, Employee Training etc.

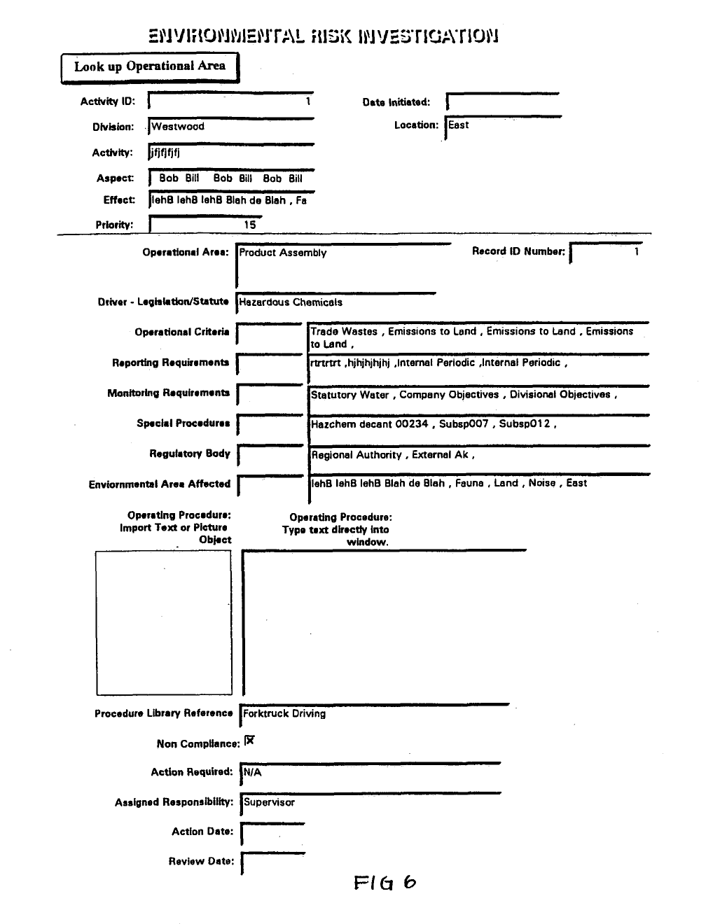

The master database and slave database associated with the Environmental Manager Module operate in the same way as in the Health and Safety Manager module previously described. FIG. 6 shows the form displayed on the input device 12 for the Environmental Risk Investigation module. As shown, the invention elicits information from the user on environmental risks in the same way as for Heath and Safety Hazards as described above.

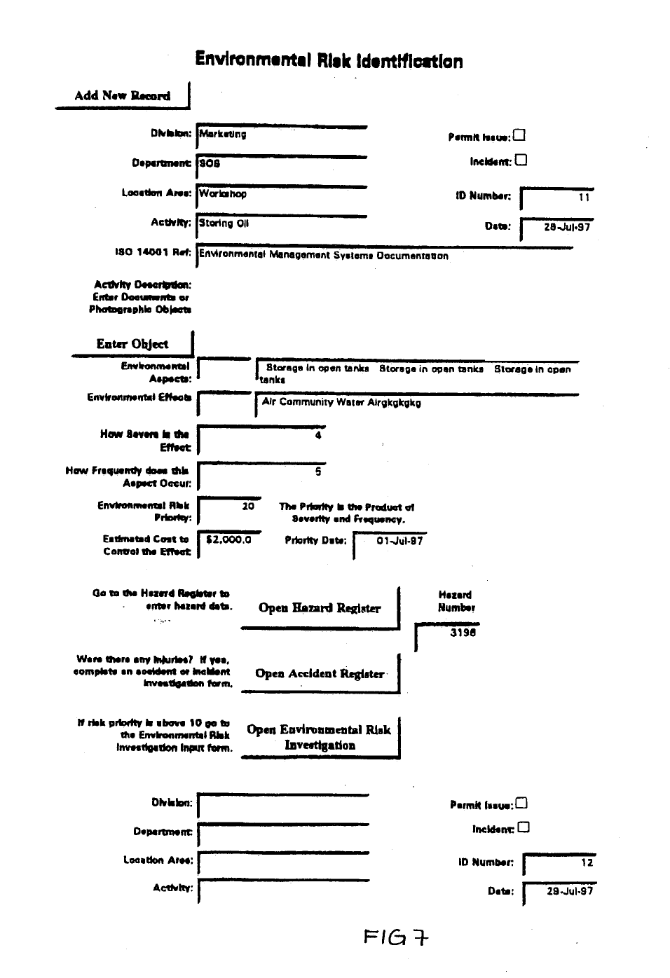

The Environmental Manager Module includes an Environmental Risk Identification form as shown in FIG. 7. The form includes an Open Hazard Register box, thereby reminding the user that identification of an environmental risk requires further input as to hazards. Once the user selects, using the input device 12, the Hazard Register, the invention automatically traverses to the Hazard Register shown in FIG. 4 ready for input by the user. This traversal is implemented by a program macro triggered by a click-event.

From the Environmental Risk Identification form the user is also able to traverse directly to the Accident Register form and the Environmental Risk Investigation form. If an actual incident occurs and is entered in the system, for example into the Hazard Register form, the system automatically traverses to the Accident/Incident Register shown in FIG. 3 where an assessment is made about the harm or potential harm of the incident.

The system then automatically traverses to the Employee Training Register where details of training are entered and compares these against training criteria obtained from the Training Document Library in the master database. Details of the training criteria are attached to the personal training record for the person involved. The system then traverses the personal record to input health assessment data required by law and prepares the health assessment routines required for the persons involved. The traversing function is continued to include hazard management for property and the environment, thereby providing a comprehensive model of management, compliance and control over individual situations.

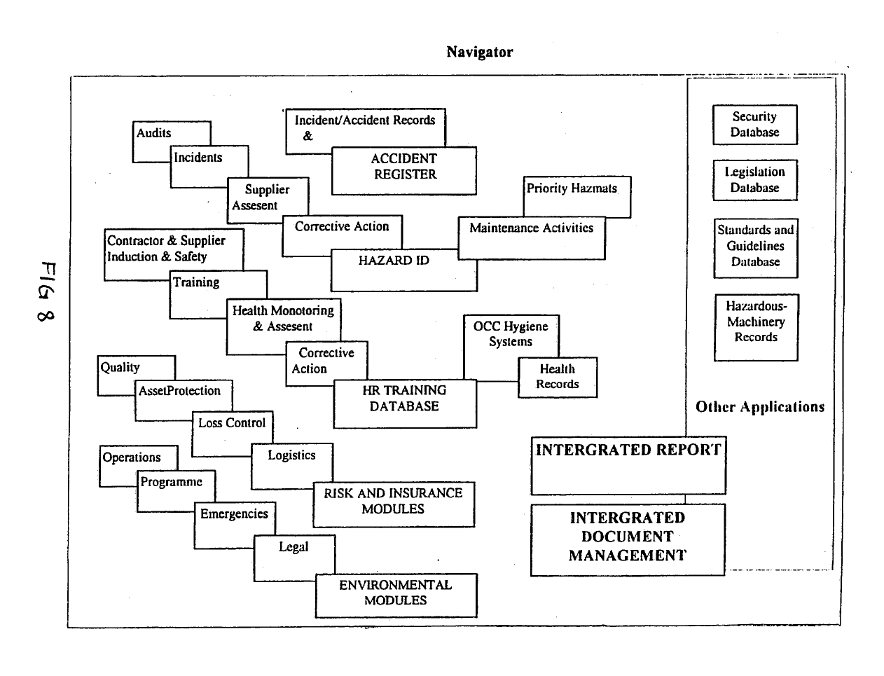

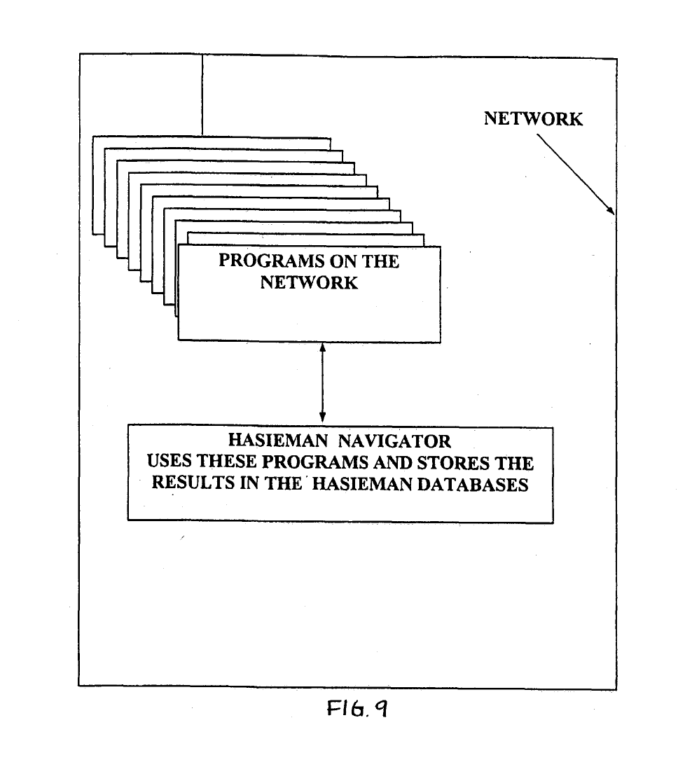

This traversal is provided by a navigator, the operation of which is illustrated in FIGS. 8 and 9. The navigator guides the user on a step-by-step basis on the actions necessary to implement compliance management procedures, through the system and through wider networks to other systems. Other systems include other software packages for example spreadsheet and word processing software and other databases. By use of the navigator, the user is able to efficiently select data and criteria for assessment from the master database of a module and attach it to the compliance issue. This navigation and assembly allows efficient and accurate compilation of data which ranges from two digit numerical ratings to billion bit data objects. The navigator may operate on an area wide network or any such networking system enabling anyone within an organization to use and interact with the system making compliance transparent at all levels of an organization.

The navigator uses its tools to locate, import and attach virtually unlimited types and amounts of data relating to compliance in the master database and attaches this information directly to each circumstance, activity and entity for entry into the slave database. This technique is used to enable a conventional office and company computer based administration programme to interface with the compliance management system. Documents, reports, spreadsheets, drawings, pictures and any other form of OLE based objects relating to compliance management generated throughout an organization are captured by the navigator and stored in the appropriate location. This information is stored in master and slave databases used to support the management criteria stored in the program.

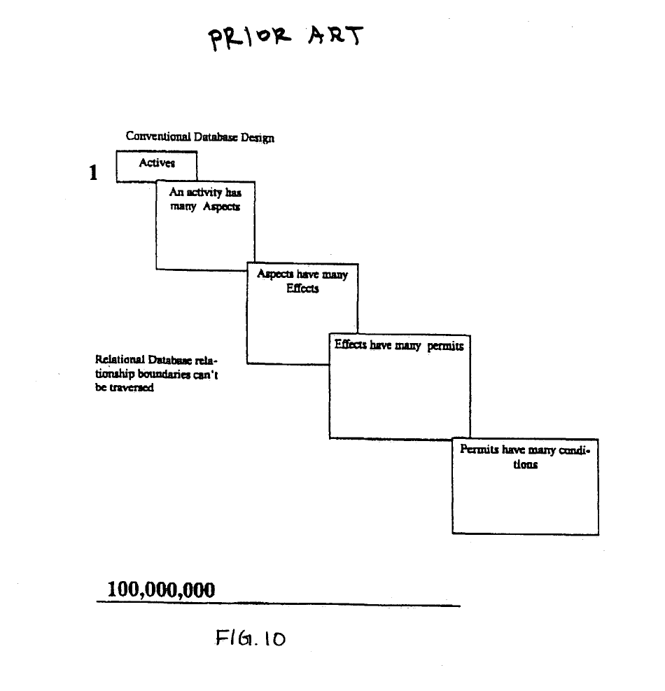

Prior art systems of this kind use relationships which are specified by the database designer when the system is implemented. An example of a prior art system is illustrated in FIG. 10. In conventional database design, relationships between tables are implemented by first identifying the fields in the tables, then setting relationships between fields using manual drag and drop actions or relationship building tools such as WIZARD. Once these relationships have been formed the relational boundaries cannot be transgressed and the relational aspects of the database design constrain use outside predefined relational criteria.

Defining relationships between tables may be difficult due to the complexity of the data represented. For example, each organization may have a number of activities in which they may engage. Each activity may have a number of aspects and each of these aspects may in turn have many effects. Each effect has a number of controls involving plans and recovery procedures to minimize the risk. The exponential number of controls needed for a single activity places significant demands on conventional database designs. A single organization may have many departments and employees. Individual employees may have accidents in departments other than the one in which they work. Other individuals who are not employees at all of the organization may have accidents in one or more departments. The present invention permits implementation of a database design in which the data is not placed in tables with predefined relationships between tables to handle these situations.

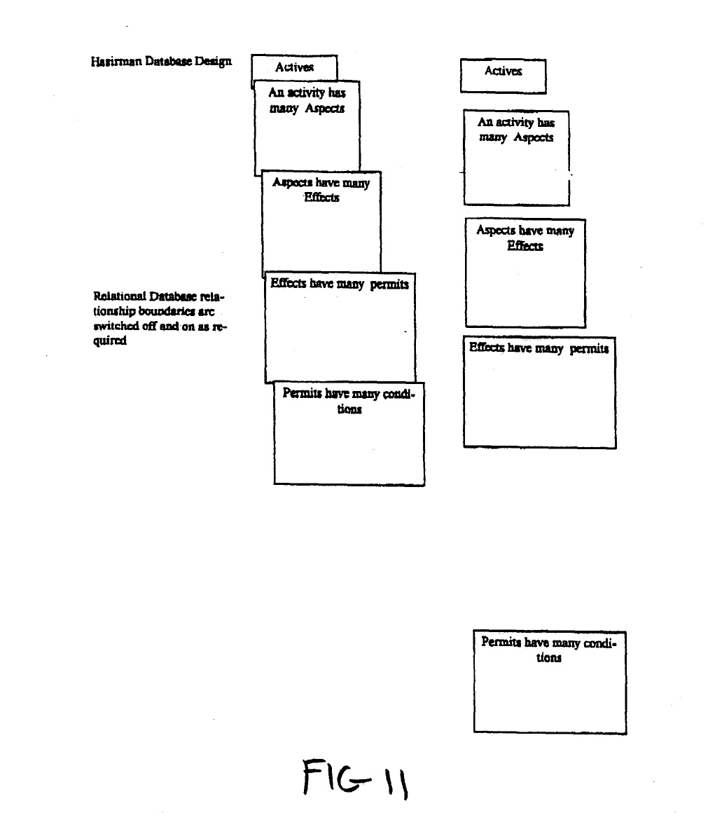

The system of the invention shown in FIG. 11 is designed with a special relational structure allowing relationships to be dynamically created and destroyed when required by the navigator.

Macros operate to make and abandon relationships which enable the relational boundaries associated with tables and queries to be traversed. The macros locate where data is physically located and what action is to be taken on it. This is essential for all tables containing compliance on such issues as health and safety of people, environment, property etc to be cross referenced so as relevant scenarios for each assessment can be compiled in the slave database tables.

Relationships between the various fields in the databases are created in the source code and switch on and off using macro functions triggered by Windows events such as click, double-click, mouse-down, mouse-move etc. This allows the macro functions to be executed when the user opens and closes the related database access forms and operating tools such as list-box and combo-boxes in the forms enabling unlimited combination of data from the fields in the master database to be assembled in the slave database.

By way of example, a department has a one to many relation with its staff (a department has many staff). However staff can have accidents in many departments which causes a conflict with this one to many relationship. The source code contains a macro that disables the relationship between the department and its staff. All staff in each department are identified and this information is made available to the user so that the user may select the staff member who has had an accident and place all relevant information about that staff member in the slave database as a record of the accident even if that person is not part of the department. This enables the many cross relationships necessary to operate the compliance program.

This macro assisted handling of relationships provides the system with greater flexibility than has previously been possible, as there are no constraints on the types of relationships which may be made between various components of the system. It also means that the modules need not be stored in a rigid data format imposed by the database designer, which may render some modules incompatible and unable to interact.

A consequence of the design of the invention means that additional modules may be incorporated into the system at a later date without substantial modification. The types of permissible modules and sub-modules may range from simple forms to complex application programs. This enables the use of a comprehensive number of software applications to interact to capture and present the data.

In summary the operation of the system of the invention is as follows:

1. The program makes provision for the entry of compliance criteria data into Master databases from company records and experience as situations arise and policy and legislative requirements are imposed.

2. Following the steps on the various risk assessment forms, the program searches through the fields in the master databases to match criteria from the master databases records with the activity being assessed.

3. This data is lodged in the fields of the slave databases to form a profile and assessment criteria for the circumstance or activity being assessed.

4. Relationships between the various fields in these databases are created in the source code and switch on and off using macro functions when opening and closing the related database access forms and operating tools such as list and combo-box icons enabling an unlimited combination of data from the fields in the master database to be assembled in the slave databases.

5. The scenarios are rated through a process of questions and answers and the selected priority issues above a criteria of 10 are reported on. Issues in the priority categories remain before management for action until all performance criteria are met.

6. The program combines and matches compliance requiremerits that transverse many areas of compliance areas and inter related issues by combining data and criteria from any part of the databases, computer and network systems. Computer and network navigation and functioning is facilitated by the navigator system.

7. The navigator uses its tools to locate, import and attach virtually unlimited types and amounts of data relating to compliance and attaches this information directly to each circumstance, activity and entity.

Using data from the various modules, the system may produce management reports including accident records together with statistics to assist an organization to implement and maintain compliance management programs. The management reports may include information about hazard management programs, workplace control procedures and checklists. Generation of these reports permits action to be taken by the organization to render it compliant with the legislative requirements in the master databases.

The foregoing describes the invention including preferred forms thereof. Alterations and modifications as will be obvious to those skilled in the art are intended to be incorporated within the scope hereof, as defined in the accompanying claims.

1. A system for assisting an organization to implement and maintain compliance management programs, the system comprising:
a graphical interface which allows a user to display and enter data about legislative obligations or other obligations with which the organization is required to comply, the interface arranged to display a plurality of user-selectable modules, each module relating to a particular piece of legislation or obligation;
at least one master database for storing compliance criteria on the legislative or other compliance obligations, the master database coupled to the graphical interface for displaying data about the legislative or other obligations;
at least one slave database for storing information on activities of and incidents or accidents in the organization and assessments of the organization, the slave database coupled to the graphical interface for user entry of data about the activities of and incidents or accidents in the organization and assessments of the organization; and
a risk assessor interfaced to assign a priority rating to the activity, incident, accident or assessment in the slave database.

2. The system according to claim 1, further comprising a report generator is configured to generate a report on any action required to render the organization compliant with the legislative or other requirements in the master database.

3. The system according to claim 1, wherein further comprising a report generator configured to generates a report on activities, incidents, accidents or assessments having a priority rating above a predefined threshold.

4. The system according to claim 3, wherein the predefined threshold may be altered, thereby allowing an organization to successively lower the threshold as the organization manages high priority activities, incidents, accidents or assessments.

5. The system according to claim 1, wherein relationships between data stored in the master database and the slave database are dynamically created and deleted as required.

6. The system according to claim 1, wherein the master database is configured to be able to be updated with additional compliance requirements.

7. The system according to claim 1, wherein the priority rating assigned comprises a numerical priority rating.

8. A computer-implemented method for assisting an organization to implement and maintain compliance management programs, the method comprising:
allowing a user to display and enter data through a graphical interface, wherein the data relates to legislative obligations or other obligations with which the organization is required to comply, the interface arranged to display a plurality of user-selectable modules, each module relating to a particular piece of legislation or obligation;
storing compliance criteria on the legislative or other compliance obligations in at least one master database coupled to the graphical interface for displaying data about the legislative or other obligations;
storing information on activities of and incidents or accidents in the organization and assessments of the organization in at least one slave database coupled to the graphical interface for user entry of data about the activities of and incidents or accidents in the organization and assessments of the organization;
assigning to the activities, incidents, accidents or assessments a priority rating and storing the priority rating in the slave database;
retrieving data from the slave database about the organization; and
retrieving legislative or other compliance requirements from the master database.

9. The method according to claim 8, further comprising generating a report on action to be taken to render the organization compliant with the legislative or other compliance requirements in the master database.

10. The method according to claim 8, further comprising generating a report on activities, incidents, accidents or assessments having a priority rating above a predefined threshold.

11. The method according to claim 12, further comprising altering the predefined threshold.

12. The method according to claim 11, wherein the altering comprises lowering the threshold as the organization manages high priority activities, incidents, accidents or assessments.

13. The method according to claim 8, further comprising dynamically creating and deleting relationships between data stored in the master database and the slave database as required.

14. The method according to claim 8, further comprising updating the master database with additional compliance requirements.

15. The method according to claim 8, wherein the priority rating assigned comprises a numerical priority rating.
